(19) United States
(12) Patent Application Publication
(10) Pub. No.: US 2013/0251866 A1
(43) Pub. Date: Sep. 26, 2013

(54) Preparation of hops

(71) Applicant: Steve C. Polley, Spearfish, SD (US)

(72) Inventor: Steve C. Polley, Spearfish, SD (US)

(21) Appl. No.: 13/506,069

(22) Filed: Mar. 23, 2012

(51) Int. Cl. C12C 3/04

(52) U.S. Cl. 426/393; 426/419

(57) ABSTRACT

Embodiments of a method and device for processing hops to insure freshness is disclosed.

### RELATED APPLICATIONS

This application relies for priority upon the Provisional Patent Application filed by Steve Polley entitled Preparation of Hops filed Mar. 23, 2011.

### BACKGROUND OF THE INVENTION

1. Field of the Invention

The present invention relates generally to hops used in brewing beer and more specifically to a method for preparing hops to maintain freshness.

2. Background Information

People have been using hops in the brewing of beer for hundreds of years. Hops are well known for loosing potency relatively quickly if not treated in some manner. The percent of active ingredients in the hops flower begin to deteriorate as soon as the flower is picked. In an effort to preserve the desired quality in hops, hops growers and processors have been baling and drying hops immediately after picking and then storing the hops at temperatures below 32 degrees F. Even when this process is used, hops should be used within a couple of months.

Several patents have been issued relating to the preservation of hops. The patent to Segal (U.S. Pat. No. 2,473,395; Jun. 14, 1949) discloses a process in which freshly picked hops are cooled to about 35 degrees F. using dry ice and then freezing them at about 25 degrees F. The hops are then thawed and dried. The patent to Muller (U.S. Pat. No. 3,275,447; Sep. 27, 1966) involves freezing hops at temperatures of −15 (5 degrees F.) to −30 (−22 degrees F.) degrees C. The patent to Yandong (CN 1978620; 2007 Jun. 13) describes another method of preserving hops. The hops are frozen and vacuum freeze dried at about −40 degrees C. (about −40 degrees F.),

Preserving hops such that they have a longer “self life” is a problem which has been around for many years. The method of preparation of hops of the instant invention is believed to be a new and unique method of preserving hops which maintains the active ingredients longer than previously known methods.

The ideal preparation of hops should be a method which preserves hops so that they maintain potency for long periods. The ideal preparation of hops should also be simple, inexpensive, and easy to use.

### SUMMARY OF THE INVENTION

The preparation of hops of the instant invention involves cryogenic freezing of the hops at a temperature of −330 degrees F. The hops are then vacuum sealed in plastic wrap which is air, water, and light resistant. The hops are then stored in a refrigerator or freezer at temperatures from 0 degrees F. to just below 32 degrees F.

In a second embodiment, the hops are dried and compressed before being vacuum sealed in plastic wrap.

One of the major objects of the preparation of hops of the instant invention is provide a method which preserves hops so that they maintain potency for long periods.

Another objective of the present invention is to provide a method for the preservations of hops which is simple, inexpensive, and easy to use.

These and other features of the invention will become apparent when taken in consideration with the following detailed description and the drawings.

### BRIEF DESCRIPTION OF THE DRAWINGS

There are no drawings.

### DESCRIPTION OF A PREFERRED EMBODIMENT

The hops flower is picked and used in most beers and lagers. Hops loose potency rapidly after being picked. The following methods have been invented to preserve hops.

The following steps provide the preferred embodiment of the instant invention for preservation of hops.

1. The hops flowers are picked;

2. As soon as possible after picking, the hops are cryogenically frozen at below −330 degrees F.;

3. The hops are then vacuum sealed in plastic wrap which is air, water, and light resistant;

4. The hops are stored at between 0 degrees F. and just below 32 degrees F. until used.

While preferred embodiments of this invention have been shown and described above, it will be apparent to those skilled in the art that various modifications may be made in these embodiments without departing from the spirit of the present invention.

In a second embodiment the following steps are taken:

1. The hops flowers are picked;

2. The hops are dried;

3. The hops are compressed;

4. The hops are vacuum sealed in plastic wrap as above;

5. the hops are cryogenically frozen at below −330 degrees F.;

6. The hops are stored at between 0 degrees F. and just below 32 degrees F. until used.

In a third embodiment:

1. The hops flowers are picked;

2. The hops are dried;

3. The hops are compressed;

4. the hops are cryogenically frozen at below −330 degrees F.;

5. The hops are stored at between 0 degrees F. and just below 32 degrees F. until used.

In a fourth embodiment:

1. The hops flowers are picked;

2. The hops are dried;

3. the hops are cryogenically frozen at below −330 degrees F.;

4. The hops are stored at between 0 degrees F. and just below 32 degrees F. until used.

In a fifth embodiment:

1. The hops flowers are picked;

2. The hops are dried;

3. The hops are cryogenically frozen at below −330 degrees F.;

4. The hops are then vacuum sealed in plastic wrap which is air, water, and light resistant;

5. The hops are stored at between 0 degrees F. and just below 32 degrees F. until used.

In a six embodiment:

1. The hops flowers are picked;

2. The hops are dried

3. The hops are cryogenically frozen at below −330 degrees F.;

4. The hops are compressed:

5. The hops are then vacuum sealed in plastic wrap which is air, water, and light resistant;

6. The hops are stored at between 0 degrees F. and just below 32 degrees F. until used.

The individual processes disclosed above are known in the field of processing agricultural crops. Picking and drying have been used to treat hops for centuries. Cyrogenic freezing is also a process which is well known, although not applied as disclosed in the instant invention. Compressing is believed to be self explanatory and vacuum packing and sealing of products is also widely known and used. It is the unique combinations of these processes which are unique to the instant invention.

While preferred embodiments of this invention have been shown and described above, it will be apparent to those skilled in the art that various modifications may be made in these embodiments without departing from the spirit of the present invention. That is, the method or device could be used for a wide variety of purposes either in combination or separately.

I claim:

1. A method for preparation of hops to be used for brewing comprising:
(1) pick the hops flowers;
(2) freeze the hops flowers cryogenically at below −330 degrees F.;
(3) vacuum seal the hops flowers in plastic wrap which is air, water, and light resistant; and
(4) store the hops flowers at between 0 degrees F. and 32 degrees F.

2. A method for preparation of hops to be used for brewing comprising:
(1) pick the hops flowers;
(2) dry the hops flowers;
(3) compress the hops flowers;
(4) vacuum seal the hops flowers in plastic wrap which is air, water, and light resistant;
(5) freeze the hops flowers cryogenically at below −330 degrees F.; and
(6) store the hops flowers at between 0 degrees F. and 32 degrees F.

3. A method for preparation of hops to be used for brewing comprising:
(1) pick the hops flowers;
(2) dry the hops flowers;
(3) freeze the hops flowers cryogenically at below −330 degrees F.:
(4) compress the hops flowers;
(5) vacuum seal the hops flowers in plastic wrap which is air, water, and light resistant; and
(6) store the hops flowers at between 0 degrees F. and 32 degrees F.

4. The method for preparation of hops of claim 3 in which the hops flowers are not compressed and are not vacuum sealed in plastic wrap.

5. The method for preparation of hops of claim 3 in which the hops flowers are not vacuum sealed in plastic wrap.

6. The method of preparation of hops of claim 3 in which the hops flowers are compressed after being dried and in which the hops flowers are not vacuum sealed in plastic wrap.
